(19) United States
(12) Patent Application Publication
(10) Pub. No.: US 2026/0229074 A1
(43) Pub. Date: Aug. 6, 2026

(54) METHOD AND COMPUTING SYSTEM FOR GUIDING REPAIR OF A VEHICLE

(71) Applicant: Intangles Lab Private Ltd., Pune (IN)

(72) Inventors: Tarun BORANA, Sumerpur (IN); Hariharan RAVISHANKAR, Bengaluru (IN); Vikram REDDY MELAPUDI, Bengaluru (IN); Yash SINGH, Bhopal (IN); Bhushan DAYARAM PATIL, Pune (IN); Abhijit VISHWAS PATIL, Bengaluru (IN); Shafaq ANSARI, Pune (IN); Nikunj ABHAY RATHOD, Thane (IN); Nikhil JOSHI, Pune (IN); Aman SINGH, Pune (IN)

(21) Appl. No.: 19/044,882

(22) Filed: Feb. 4, 2025

(51) Int. Cl. G07C 5/08

(52) U.S. Cl. CPC G07C 5/0808

(57) ABSTRACT

A method for guiding repair of a vehicle. The method comprises receiving, by an interface module, diagnostic trouble codes generated by the vehicle. Each diagnostic trouble code is associated with at least one fault occurrence of the vehicle having at least one possible cause. The method further comprises extracting, by a processor, possible causes for a fault occurrence from the diagnostic trouble codes and identifying components of the vehicle that are associated with those causes, and determining, by the processor, common components between the diagnostic trouble codes based on an identification of the components of the vehicle that could be contributing to each fault occurrence. The common components are those that are identified as being associated with fault occurrences of two of more diagnostic trouble codes. The method additionally comprises ordering, by the processor, the possible causes based on the identified common components, and outputting, by an output module, a recommendation for a sequence of repairing the vehicle based on the ordered possible causes.

### TECHNICAL FIELD

The present disclosure relates to a method and computing system for guiding repair of a vehicle.

### BACKGROUND

Service manuals are typically available to assist workshop technicians and vehicle owners in repairing vehicles, for example by providing step-by-step instructions for vehicle repair. However, these typically cover many different possible faults that may occur with a vehicle when it needs repair and it is up to the skill and knowledge of the workshop technician or owner to diagnose a fault and carry out any appropriate repairs based on the information provided in the service manual. Further, service manuals may not always contain the most current information, because they are typically created during the development of the vehicle, and often some significant time before the vehicle is actually made available to customers. Furthermore, diagnostic techniques and procedures for repairing the vehicle may change over time, as issues and different fault occurrences may not become apparent until that particular type of vehicle has been used for some considerable time.

To address this, it is known to use diagnostic trouble codes (DTCs) generated by the vehicle to assist in providing guidance to a workshop technician or owner when repairing the vehicle. For example, on occurrence of a fault, a workshop technician may use a suitable data interface device to download diagnostic trouble codes from the vehicle. The DTCs may typically be provided with a description of the code, symptoms of an associated fault, and a list of possible causes. Information about the DTCs may be provided to someone who is repairing the vehicle to assist them when performing repairs.

However, while this information can be helpful to someone trying to repair the vehicle, if there are several DTCs output by the vehicle in association with the fault occurrence, it is generally left to the skill and knowledge of that person to decide which DTCs could be the most relevant and then decide on an appropriate course of action or sequence of investigations and repairs in order to diagnose and repair the vehicle. Therefore, there is a need for system and methods which may help guide a person who is fixing and repairing a vehicle in a more efficient manner and help to reduce time, expense, and effort that may be needed to repair the vehicle.

### SUMMARY

Examples of the present disclosure seek to address or at least alleviate the above problems.

In a first aspect, there is provided a method for guiding repair of a vehicle, the method comprising: receiving, by an interface module, diagnostic trouble codes generated by the vehicle, in which each diagnostic trouble code is associated with at least one fault occurrence of the vehicle having at least one possible cause; extracting, by a processor, possible causes for a fault occurrence from the diagnostic trouble codes and identifying components of the vehicle that are associated with those causes; determining, by the processor, common components between the diagnostic trouble codes based on an identification of the components of the vehicle that could be contributing to each fault occurrence, the common components being those that are identified as being associated with fault occurrences of two of more diagnostic trouble codes; ordering, by the processor, the possible causes based on the identified common components; and outputting, by an output module, a recommendation for a sequence of repairing the vehicle based on the ordered possible causes.

In a second aspect there is provided a computing system for guiding repair of a vehicle, the system comprising: an interface module configured to receive diagnostic trouble codes generated by the vehicle, in which each diagnostic trouble code is associated with at least one fault occurrence of the vehicle having at least one possible cause; a processor configure to: extract possible causes for a fault occurrence from the diagnostic trouble codes and identify components of the vehicle that are associated with those causes; determine common components between the diagnostic trouble codes based on an identification of the components of the vehicle that could be contributing to each fault occurrence, the common components being those that are identified as being associated with fault occurrences of two of more diagnostic trouble codes; and order the possible causes based on the identified common components; and an output module configured to output a recommendation for a sequence of repairing the vehicle based on the ordered possible causes.

Other aspects and features are defined in the appended claims.

Accordingly, examples of the disclosure may help speed up vehicle repair by providing recommendations for an order in which components of a vehicle should be investigated for faults. For example, a recommendation may be based on frequently occurring part failures, i.e. component failures that may often occur, based on a particular component being found to be in common with more than one DTC. For example, the recommendation can suggest the most likely components that could be giving rise to the fault occurrence so that a user, such as a repair technician can investigate those first. Therefore, the speed and accuracy with which guided repair recommendations can be made may be improved. This may also help reduce time, labour, and cost when repairing a vehicle. For example, a down time of fleet vehicles, such as truck and lorries, which may cause considerable disruption to a supply chain and cost for a fleet operator, may accordingly be reduced.

### BRIEF DESCRIPTION OF THE DRAWINGS

Examples of the disclosure will now be described by way of example only with reference to the accompanying drawings, in which like references refer to like parts, and in which:

FIG. 1 schematically shows an arrangement for providing diagnostic trouble codes (DTCs) to a computing system for guiding repair of a vehicle;

FIG. 2 shows a method for guiding repair of a vehicle;

FIG. 3 schematically shows input of diagnostic codes to the computing system;

FIG. 4 shows an example of diagnostic data;

FIG. 5a shows an example of a knowledge graph;

FIG. 5b shows an example of a knowledge tree;

FIG. 5c illustrates an example of grouping of diagnostic trouble codes to form part of a knowledge graph;

FIG. 6 shows an example of a display window for guiding repair;

FIG. 7 shows a method for generating a score based on matching between causes associated with DTCs.

FIG. 8 shows an example of a user feedback interface matrix; and

FIG. 9 schematically shows an example of a computer system for implementing methods of examples of the disclosure

### DETAILED DESCRIPTION

A method and system for guiding repair of a vehicle is disclosed. In the following description, a number of specific details are presented in order to provide a thorough understanding of the examples of the disclosure. It will be apparent however to a person skilled in the art that these specific details need not be employed in order to practise the examples of the disclosure. Conversely, specific details known to the person skilled in the art are omitted for the purposes of clarity in presenting the examples.

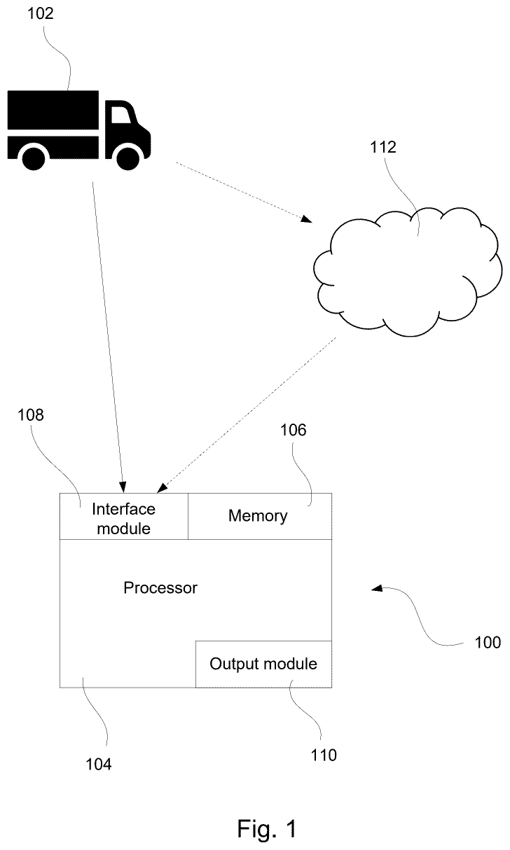

FIG. 1 schematically shows an arrangement for providing diagnostic trouble codes (DTCs) to a computing system 100 for guiding repair of a vehicle 102 according to examples of the disclosure. The vehicle 102 may be provided with sensors, for example mounted on or around an engine of the vehicle, as well as other functional parts of the vehicle such as drive train, brake lines, and exhaust system for monitoring operational parameters and conditions of the vehicle. The sensors may detect different modalities and provide measurements used by an engine management system of the engine to calculate various performance parameters. The data from such sensors may, for example, be used by an engine control unit (ECU) to control operation of the engine. An onboard diagnostics (OBD) system of the vehicle 102 may use data from the sensors to monitor operation of the vehicle and may generate one or more diagnostic trouble codes in response to detecting a malfunction in one or more of the vehicle's systems.

The computing system 100 comprises a processor 104, and memory 106, and interface module 108, and an output module 110, which are configured to cooperate together, for example based on computer executable instructions stored in the memory 106 to implement the techniques and methods described herein.

The interface module 108 may be configured to communicate with a telematics gateway unit of the vehicle 102 for communication with the computing system 100 via a wired or wireless link, for example to provide the DTCs generated by the OBD system to the computing system 100. In some examples, DTCs may be provided to the computing system 100 via a cloud based, or distributed computing network 112. The computing system 100 may be separate from the vehicle 102 or may form part of the distributed computing network 112. Alternatively, the computing system 100 may be provided onboard the vehicle 102.

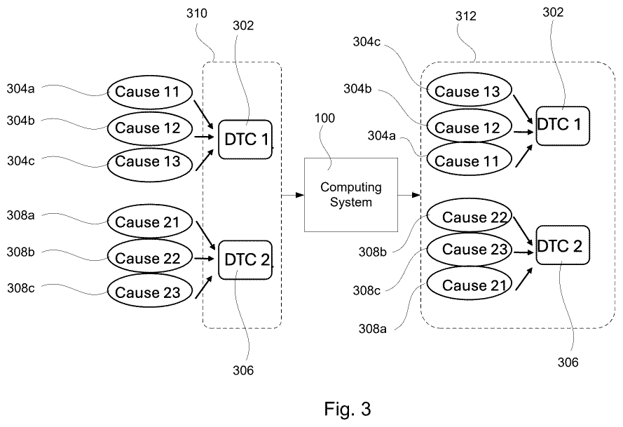

At a step s202, the interface module 108 receives diagnostic trouble codes generated by the vehicle 102. Each diagnostic trouble code (DTC) may be associated with at least one fault occurrence of the vehicle having at least one possible cause. For example, referring to FIG. 3, a first DTC 302 may be associated with a fault occurrence having a first possible cause 304a, a second possible cause 304b, and a third possible cause 304c. A second DTC 306 may be associated with a fault occurrence having a first possible cause 308a, a second possible cause 308b, and third possible cause 308c. In other words, for example, diagnostic data 310 comprising the diagnostic trouble codes 302, 306, and causes 304a-c, 308a-c may be received by the interface module 108 of the computing system 100. As used herein, the term “active” in relation to codes and DTCs relates to the DTCs in the diagnostic data 310 that are received from the vehicle 102 by the interface module 108.

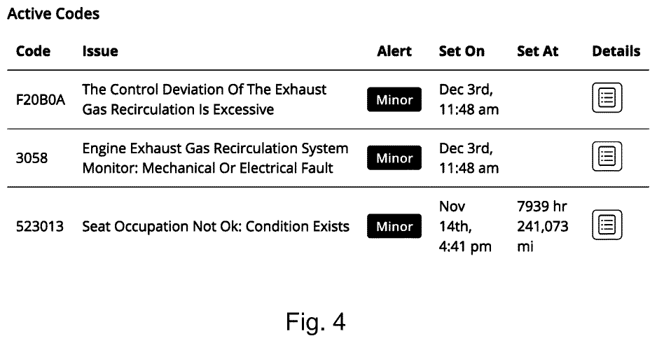

In some examples, the diagnostic data 310 may comprise the diagnostic trouble codes together with their associated causes, and one or more of timestamp data, alert priority data, and explanatory data relating to a description of an issue associated with each DTC, for example as shown in FIG. 4.

At a step s204, the processor 104 extracts possible causes for a fault occurrence from the diagnostic trouble codes and identifies components of the vehicle that are associated with those causes. In some examples, extracting the possible causes from the diagnostic trouble codes and identifying the components of the vehicle that are associated with respective causes is based on a knowledge graph.

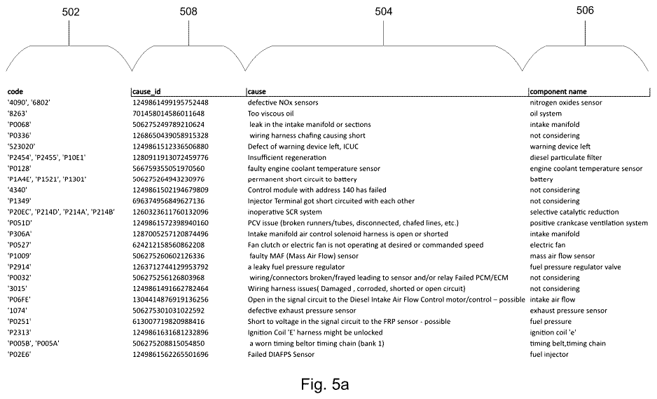

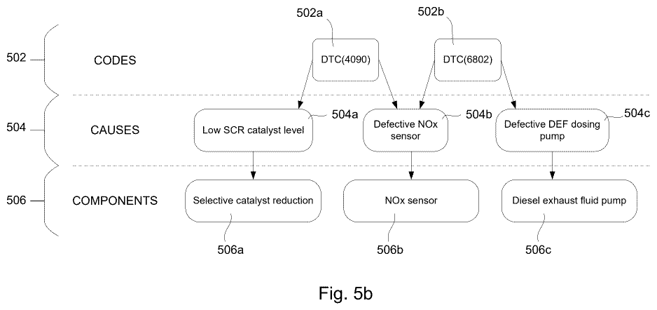

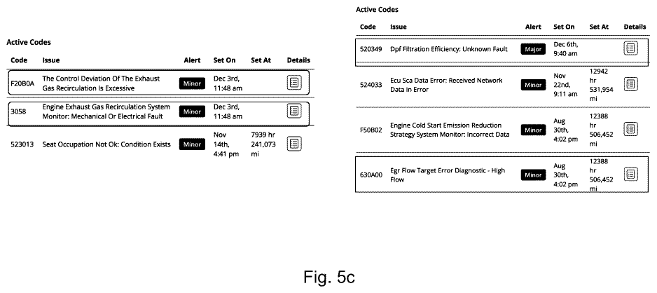

FIGS. 5a and 5b show examples of knowledge graphs which may be implemented to assist in extracting possible causes for a fault occurrence. FIG. 5a shows an example of part of a knowledge graph implemented as a database, and FIG. 5b shows an example of part of a knowledge graph implemented as a knowledge tree. FIG. 5c illustrates an example of grouping of DTCs to form part of a knowledge graph, such as the those shown in FIGS. 5a and 5b.

For example, referring to FIG. 5a, the knowledge graph comprises entries for DTC codes 502, causes 504, and components 506, such as the DTC codes “4090” and “6802” being associated with the cause “defective NOx sensors” along with the component “nitrogen oxide sensor”. Each cause 504 may have an associated cause ID 508, which uniquely identifies that cause.

Turning to FIG. 5b, the relationship between each DTC and one or more causes associated with that DTC may be represented in a knowledge tree. For example, the DTC (4090) 502a may be associated with both the causes “Low SCR catalyst level” 504a and “Defective NOx sensor” 504b, and the DTC (6802) 502b may be associated with both the causes “Defective NOx sensor” 504b and “Defective DEF dosing pump” 504c. The cause “Low SCR catalyst level” 504a may be associated with a component “Selective catalyst reduction” 506a, the cause “defective NOx sensor” 504b may be associated with a component “NOx sensor” 506b, and the cause “Defective DEF dosing pump” 504c may be associated with a component “Diesel exhaust fluid pump” 506c. In examples, the knowledge graph may be generated from the DTCs based on utilization of prompting a large language model (LLM) to identify the components of the vehicle that are associated with the respective diagnostic trouble codes and determine possible causes of the diagnostic trouble codes. Large language models (LLMs) such as ChatGPT by OpenAl, Google Gemini, and Microsoft Copilot are known in the art. However, a general LLM could be fine-tuned 20 specifically on DTC and cause data so as to help provide a more content specific output. For example, a suitable prompt may be:

“You are an expert automotive technician tasked with diagnosing and resolving a diagnostic trouble code (DTC). Your goal is to extract the specific component with given cause in order to effectively diagnose and repair the vehicle. Example
1) cause-low or excessive fuel pressure. Extracted component-fuel pressure.
2) cause-faulty engine control unit. extracted component-engine control unit.
Please provide shortly component for cause-{query}?”

However, it will be appreciated that other suitable prompts could be used. The prompt May be applied to all possible DTCs in order to generate the knowledge graph. Additionally, further prompting may be applied based on the output of the LLM in order to arrive at a satisfactory association between DTC, causes, and components. In these examples, the knowledge graph may be stored in the memory 106 prior to extracting the possible causes and identifying the components that are associated with them. This may help reduce processing resources needed when extracting the possible causes for a fault occurrence from the received diagnostic data 310. In some cases, the output of the LLM in creating the knowledge tree may be augmented or edited by input from a user, in order to help provide consistency. An edited knowledge tree may then be provided back to the LLM as a further prompt in order to help refine future output of the LLM. However, in other examples, the knowledge graph may be generated substantially in real time.

In other examples, the prompt may be applied only to the diagnostic data 301 received by the interface module 108, which may help reduce processing resources since a reduced dataset compared with a knowledge graph generated from all possible DTCs can be considered.

At a step s206, the processor 104 determines common components between the diagnostic trouble codes based on an identification of the components of the vehicle that could be contributing to each fault occurrence. The common components may be those that are identified as being associated with fault occurrences of two of more diagnostic trouble codes.

For example, referring to the knowledge tree of FIG. 5b, the component NOx sensor 506b is associated with both DTC (4090) 502a and DTC (6802) 502b via the cause 504b. The determination of common components may therefore, for example, be thought of as identifying DTCs associated with more than one component 506 that is found to be in common with the causes 504 associated with the respective DTC codes 502.

At a step s208, the processor 104 orders the possible causes based on the identified common components. In examples, the causes may be ordered from most likely to least likely. In examples, a total score may be generated for each cause that is indicative of the likelihood of that cause contributing to the occurrence of the fault indicated by the associated diagnostic trouble code. Ordering the possible causes may be based on the respective total score for each cause. For example, the diagnostic data 310 input to the computing system may comprise DTCs and their associated causes ordered as shown in Table 1A:

TABLE 1A

| DTCa | DTCb | DTCc |
|---|---|---|
| Cause a1 | Cause b1 | Cause c1 |
| Cause a2 | Cause b2 | Cause c2 |
| Cause a3 | Cause b3 | Cause c3 |
| Cause a4 | Cause b4 | |

In ordering the possible cause based on identified components, the most likely causes may be positioned to appear first in a list of possible causes for each DTC, for example as illustrated in Table 1B (most likely causes are shown in bold type). In other words, for example, the causes associated with the DTCs can be thought of as being ordered so as to place the most likely possible causes first in a list of causes associated with each respective DTC.

TABLE 1B

| DTCa | DTCb | DTCc |
|---|---|---|
| Cause a3 | Cause b4 | Cause c1 |
| Cause a1 | Cause b2 | Cause c2 |
| Cause a2 | Cause b1 | Cause c3 |
| Cause a4 | Cause b3 | |

At a step s210, the output module 110 outputs a recommendation for a sequence of repairing the vehicle based on the ordered possible causes. For example, a recommendation 312 for guided repair may be provided via the output module 110.

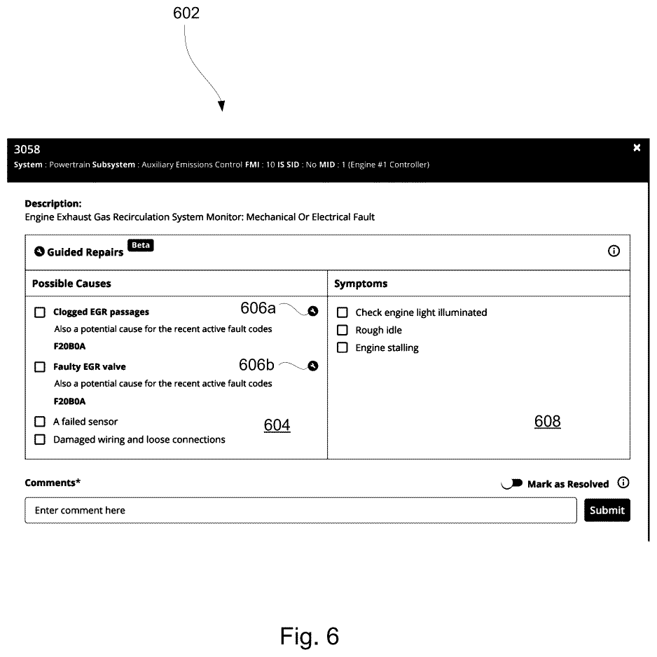

In examples, the recommendation may be provided in a display window 602 to a repair technician by a suitable display device via the output module 110, for example as shown in FIG. 6. In examples, the most likely causes may be shown within a first display portion 604 of the display window 602 corresponding to “possible causes” The most likely cause that could be giving rise to the fault occurrence(s) may be displayed towards to upper part of the first display portion 604, for example at the top of a list.

In examples, the most likely possible causes may be highlighted with one or more icons, such as icon 606a and icon 606b. In some examples, the recommendation may be used to generate automated work orders for repairing the vehicle, for example based on the ordering of the likely causes. For example, automated work orders may be used to place requests for replacement parts from a supplier by interfacing with an online portal.

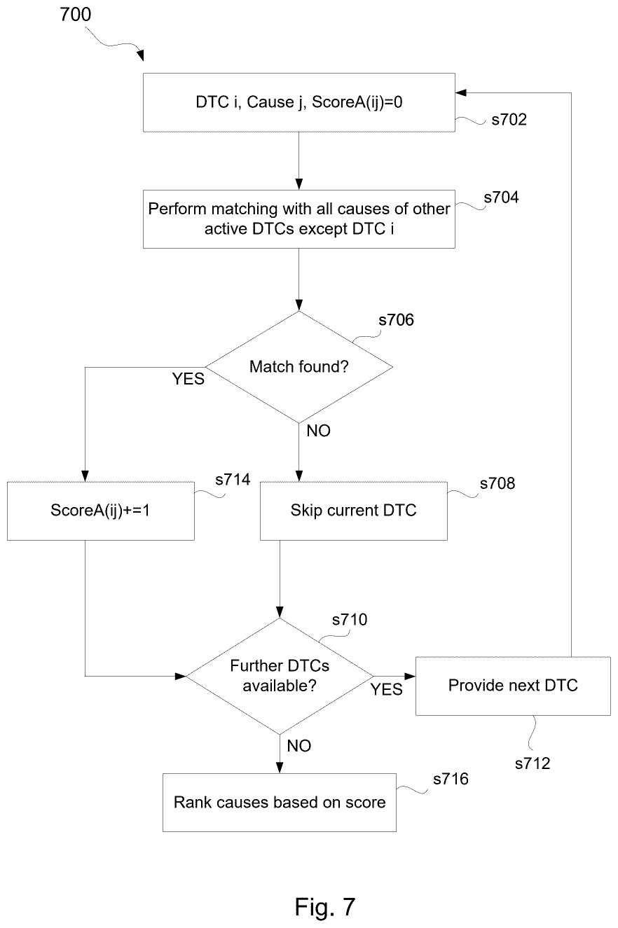

As mentioned above, in some examples, a total score may be generated for each cause that is indicative of the likelihood of that cause contributing to the occurrence of the fault indicated by the associated diagnostic trouble code, and ordering the possible causes may be based on the respective score for each cause. Further details will now be described with reference to FIG. 7.

FIG. 7 shows a method 700 for generating a score based on matching between causes associated with DTCs. The diagnostic data 310 input to the interface module 108 may be used as the input data to provide the DTCs, and the processor may index each DTC of the received diagnostic data with a suitable index such as DTC i.

At a first step s702, a DTC with index i, and having associated causes with index j, and with an associated ScoreA(ij) is input for processing by the processor 104. Initially, the ScoreA(ij) is set to zero i.e. ScoreA(ij)=0. More generally, a score for each cause j having associated DTC i for each cause may be considered to be Score(ij). In some examples, the total score, Score(ij), comprises only ScoreA(ij), although in some examples, the total score, Score(ij), comprises the ScoreA(ij) together with one or more other scoring parameters. The scoring paraments may be based on scoring types as described later below.

At a step s704, the processor 104, performs matching between the causes j associated with DTC i and all causes j of other active DTCs except those of DTC i. Matching may be performed based on keyword matching of associated component names between the causes associated with DTC i and causes j of the other active DTCs, although it will be appreciated that other techniques for matching causes may be utilized. As mentioned above, the association between DTCs, causes, and components may be based on a knowledge graph.

At a step s706, the processor 104 determines if one or more matches have been found or not. If no matches were found, then, at a step s708, the current DTC is skipped (passed) and processing proceeds to a step s710 in which the processor determines whether further DTCs are available for matching. If further DTCs are available (e.g. not all DTCs of the received diagnostic data 310 have yet been processed), then at a step s712 the next DTC is provided and used as the input DTC for the step s702. In other words, for example, the index i of the DTC may be incremented by 1, so that the next DTC of the DTCs received in the diagnostic data 310 is considered at the step s702.

If, at the step s706, the processor 104 determines that there one or more causes of the current DTC (DTC i) match one or more causes of the other DTCs of the DTCS i of the diagnostic data 310, then at a step s714, the value of ScoreA(ij) is incremented by 1 (increased by 1). The matching may be based on keyword matching, but other techniques could be used.

In other words, more generally, each score may comprise a matching score (e.g. ScoreA(ij) that is based on a degree of matching between components of causes belonging to different diagnostic trouble codes (e.g. DTC i).

Following the step s706, processing then proceeds to the step s710 in which it is determined if further DTCs are available or not. If further DTCs are available for processing, then the step s702 is implemented as described above, and the next DTC provided as input to the step s702.

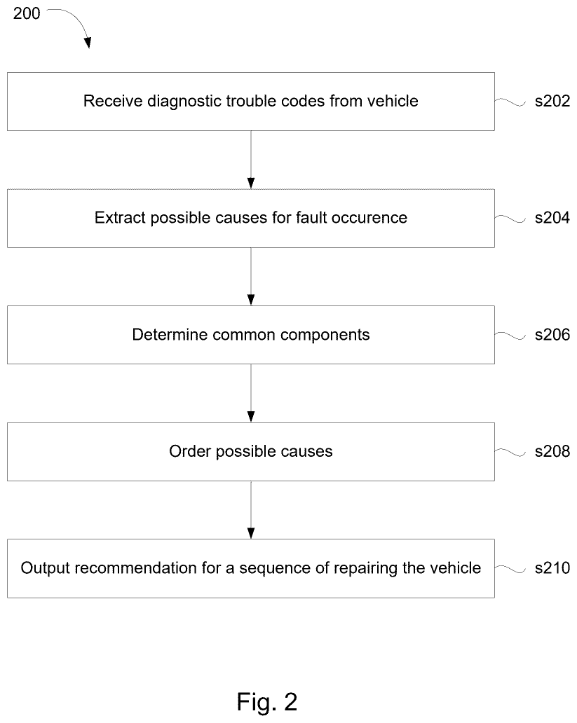

If no further DTCs are available (e.g. all the received DTCs of the diagnostic data 310 have been processed), then at a step s716, the processor ranks the causes based on their associated score. For example, the causes may be ranked from highest value of ScoreA(ij) to lowest value of ScoreA(ij). This ranking may then be used to generate the recommendation for the sequence of repairing the vehicle in the step s210 described above with reference to FIG. 2.

In examples, the total score, Score(ij), may comprise the ScoreA(ij) together with one or more other scoring parameters. In some examples, in addition to the score based on matching (e.g. ScoreA(ij)) each total score (e.g. Score(ij)) comprises one or more of: a predictive alert score (ScoreB) based on a predictive alert associated with a cause; a user feedback score (ScoreC) based on customer feedback relating to the occurrence of that cause; a vehicle repair history score (ScoreD) based on repair history of the vehicle; a symptom score (ScoreE) based on reported symptoms coinciding with a fault occurrence; and a duration score (ScoreF) based on a duration of engine operation for which a diagnostic trouble code is present. In some examples, the total score, Score(ij), may comprise just the ScoreA(ij) together with the ScoreF.

The scores, ScoreA, ScoreB, ScoreC, ScoreD, ScoreE, and ScoreF may be thought of as score types.

In some examples, all score types (e.g. ScoreA, ScoreB, ScoreC, ScoreD, ScoreE, ScoreF) may be used to include in generating the total score, Score(ij), although in other examples, Score type ScoreA may be included but one or more of the other score types (e.g. ScoreB, ScoreC, ScoreD, ScoreE) may be omitted from generating the total score, Score(ij), for example, based on computing resources required. For example, the inclusion of fewer score types may mean that there is less data to process, helping to reduce memory and processing resources needed, while including more score types may help improve the accuracy recommendations and hence help speed up repair.

In some examples, each score type may have an associated weighting factor. The respective weighting factors may be used to determine how much each score type contributes to the total score, Score(ij).

In examples, the total score, Score(ij), is given by:

$$Score ( ij ) = α ScoreA ( ij ) + β ScoreB + γ ScoreC + δ ScoreD + ε ScoreE + μ ScoreF$$

Here, α may be a weighting factor for the ScoreA that is based on matching, and for example, generated according to the method 700 of FIG. 7. β may be a weighting factor for ScoreB e.g. relating to predictive alerts. γ may be a weighting factor for ScoreC relating to user feedback. δ may be a weighting factor for ScoreD relating to vehicle repair history. ε may be a weighting factor for ScoreE relating to reported symptoms. μ may be a weighting factor for ScoreF relating to duration of engine operation with an associated DTC. The weighting factors α, β, γ, δ, ε, and μ may be chosen based on the degree to which each score type should influence the total score Score(ij). In examples, the weighting factors α, β, γ, δ, ε, and μ may be normalized so that when taken together, they sum to unity.

The score type ScoreB and its weighting factor β may be based on so-called predictive alerts. Predictive alerts may be generated based on predicting a likelihood of one or more faults occurring by analysing engine data and other vehicle data, for example by analysing one or more of fuel rail pressure data, engine coolant temperature data, diesel particulate filter status data, battery and alternator performance data, and air intake diagnostic data.

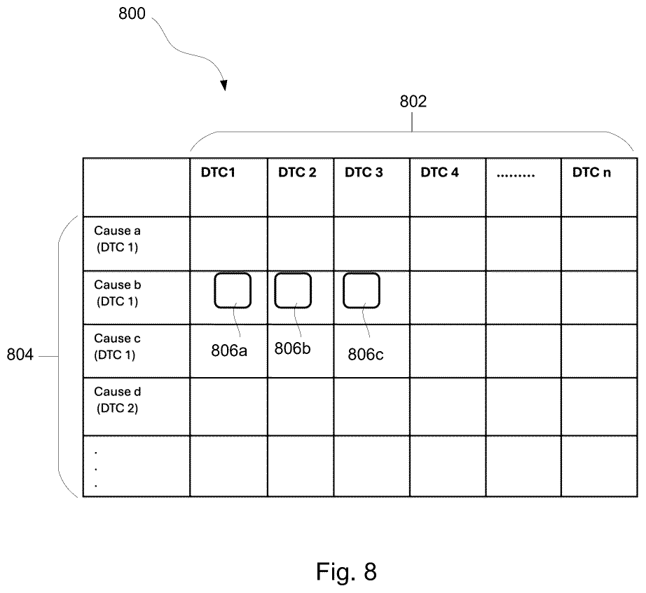

The score type ScoreC and its related weighting factor γ may be considered with respect to user feedback, for example that may be provided while repairs are being carried out on the vehicle. Referring to FIG. 8, the module 110 may be configured to provide, under control of the processor 104, a user feedback interface matrix 800. In examples, the DTCs (with index DTC i) are arranged in columns 802, and the associated causes (cause j) are arranged in rows 804. In the example shown in FIG. 8, the DTCs are associated with causes as illustrated in the example of Table 2 (note that not all the relationships between DTCs and causes given in Table 2 are illustrated in FIG. 8).

TABLE 2

| DTC1 | DTC2 | DTC3 |
|---|---|---|
| Cause a | Cause d | Cause f |
| Cause b | Cause e | Cause g |
| Cause c | | Cause h |
| | | Cause i |

A user, such as a repair technician or vehicle owner, may provide user feedback while carrying out repairs by suitable input to the user feedback interface matrix 800 such as that illustrated in FIG. 8. For example, the user may use an input device (such as a computer mouse) to click on one or more input regions (such as input regions 806a, 806b, 806c) within the matrix 800 to provide feedback regarding identified causes and their related DTCs.

Taking Cause b by way of example, if a user indicates that the Cause b is present irrespective of other DTCs by clicking in the input region 806a, then a value M (Cause b(DTC1), DTC1) is incremented by 1 (in other words M (Cause b(DTC1), DTC1)+=1)), else the value is incremented by zero (or remains as it is).

If, for example, the user indicates that the Cause b is present with DTC2 by clicking in the input region 806b, then a value M (Cause b(DTC1), DTC2) is incremented by 1 (in other words M (Cause b(DTC1), DTC2)+=1)), else the value is incremented by zero (or remains as it is).

If, for example, the user indicates that the Cause b is present with DTC3 by clicking in the input region 806c, then a value M (Cause b(DTC1), DTC3) is incremented by 1 (in other words M (Cause b(DTC1), DTC3)+=1)), else the value is incremented by zero (or remains as it is).

In examples, the score type ScoreC may be updated substantially in real time in response to user feedback via the user feedback interface matrix 800. For example, a ScoreC relating to cause b(DTC1) due to user feedback substantially in real time may be determined by normalizing the sum of all columns 802 of DTCs that intersect with the row 804 corresponding to cause b(DTC1). In contributing to the total score Score(ij), the ScoreC may then be weighted accordingly based on the associated weighting factor γ.

As mentioned above, the score type ScoreD may be based on vehicle repair history. In an example, a repair history matrix may be provided to a user via a user interface, by which a user can input which repairs were carried out and the causes that were present when the repair was made. For example, a matrix similar to that of FIG. 8 may be used with types of repair and the respective components being indicated in the columns and thus associated with respective causes by user input to an input region at their intersection (similar to input to input regions 806a, 806b, or 806c). In other words, the columns may be Repair1, Repair2, Repair3 . . . . RepairN, and the Score D incremented in the same manner as described above with respect to the association between the RepairN and the Cause.

In examples, the score type ScoreD may be updated in response to user feedback via the repair history matrix. For example, by analogy with FIG. 8, a ScoreD relating to cause b(DTC1) due to user feedback to the repair history matrix may be determined by normalizing the sum of all columns of repairs (RepairN) that intersect with the row corresponding to cause b(DTC1). In contributing to the total score Score(ij), the ScoreD may then be weighted accordingly based on the associated weighting factor δ.

Further, as mentioned above, the score type ScoreE may be based on reported symptoms. The reported symptoms may relate to one of more fault occurrences, and may be reported by a user via a suitable interface such as within a symptom input portion 608 of the display window 602 (see e.g. FIG. 6).

As mentioned above, in some examples, the total score (e.g. Score(ij)) may comprise the may comprise the ScoreA(ij) together with the ScoreF, which is based on a duration of engine operation for which a diagnostic trouble code is present. In an example, engine operation time data D hr during which the DTC was present may be obtained from the vehicle via the interface module 108 in communication with the telematics gateway unit of the vehicle 102 together with any associated DTCs.

Here, D hr is the duration of time that the engine of the vehicle was operating and for which the DTC was present. This helps take into account that a vehicle may not be used for some time (e.g. several days, weeks, or months) and so if absolute time is used, then this would likely provide an inaccurate representation of how long a fault was present for, and how it may be affecting engine operation. For example, the engine of the vehicle may be operating for a total period of 12 hours over the course of 1 week, and a DTC associated with a particular component may only be present for 6 hours out of the 12 hours of operation time. In this example, D hr would be 6 hours, for this particular component.

The processor 104 may obtain the components of each DTC that has an associated D hr value in a similar manner to that described above, for example based on a knowledge graph, or substantially real-time use of a large language model.

The duration of time D hr for each component may then be normalized and combined, for example:
Component A: Normalise (Duration x),
Component B: Normalise (Duration y),
Component C: Normalise (Duration z)

The ScoreF may then be generated so that for each component j (referring to FIG. 7 for example), ScoreF=normalized value of component j. This may, for example, be carried out at the step s714 in FIG. 7. The ScoreF(ij) is then taken to be the sum of the normalized values for each component. Where more than one component is present for a DTC, then the mean average of the normalized values is calculated and set as ScoreF by the processor 102.

In some examples, the ScoreF, may be based on the duration of engine operation for which a diagnostic trouble code is present as well as a duration of engine operation that has an associated predictive alert. In an example, engine operation time data D hr during which a predictive alert was present may be obtained from the vehicle via the interface module 108 in communication with the telematics gateway unit of the vehicle 102 together with any associated DTCs.

A similar process for calculating ScoreF may be carried out by additionally using the duration operation time data of the predictive alerts. The processor 104 may obtain the components of each predictive alert that has an associated D hr value in a similar manner to that described above, for example based on a knowledge graph, or substantially real-time use of a large language model.

The D hr value for component extracted from the predictive alerts may be combined with the D hr value of the same component extracted from the DTC and normalized, and the ScoreF generated as mentioned above.

The use of ScoreF may help improve the accuracy of the recommendations because the total score may more accurately be related to operation of the engine as it is based on duration of the time for which an alert and/or predictive alert was present.

Accordingly, by combining the score type ScoreA in relation to matching of causes together with one or more other score types, such as ScoreB, ScoreC, ScoreD, ScoreE, and ScoreF the accuracy and speed at which a recommendation for guided repair may be provided may be improved.

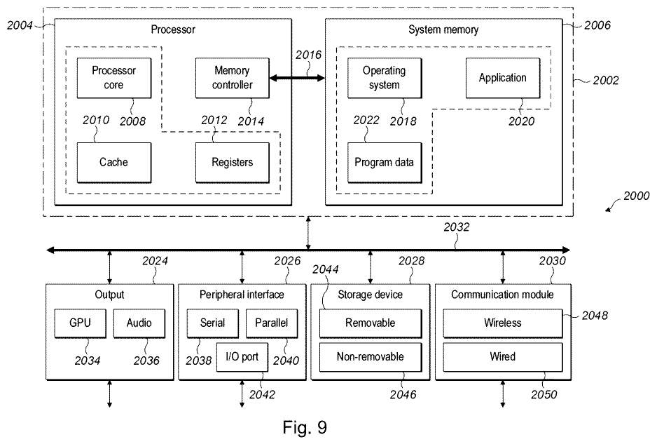

FIG. 9 schematically shows an example of a computer system for implementing methods of examples of the disclosure. In particular, FIG. 9 shows an example of a computing device 2000 for example which may be arranged to implement one or more of the examples of the methods described herein. The computing device 2000 may be used to implement the functionality of the computing system 100 described herein.

In examples, the computing device 2000 comprises main unit 2002. The main unit 2002 may comprise a processor 2004 and a system memory 2006. In examples, the processor 2004 may comprise a processor core 2008, a cache 2010, and one or more registers 2012. In examples, the processor core 2008 may comprise one or more processing cores and may comprise a plurality of cores which may run a plurality of threads. The processor 2004 may be of any suitable type such as microcontroller, microprocessor, digital signal processor or a combination of these, although it will be appreciated that other types of processor may be used.

In examples, the processor core 2008 may comprise one or more processing units. In examples, the processor core 2008 comprises one or more of a floating point unit, an arithmetic unit, a digital signal processing unit, or a combination of these and/or plurality of other processing units, although it will be appreciated that other processing units could be used. In examples, the cache 2010 may comprise a plurality of caches such as a level one cache and a level two cache, although other appropriate cache arrangements could be used.

In examples, the processor 2004 comprises a memory controller 2014 operable to allow communication between the processor 2004 and the system memory 2006 via a memory bus 2016. The memory controller 2014 may be implemented as an integral part of the processor 2004, or it may be implemented as separate component.

In examples, the system memory 2006 may be of any suitable type such as non-volatile memory (e.g. flash memory or read only memory), volatile memory (such as random access memory (RAM)), and/or a combination of volatile and non-volatile memory. In examples, the system memory 2006 may be arranged to store code for execution by the processor 2004 and/or data related to the execution. For example, the system memory may store operating system code 2018, application code 2020, and program data 2022. In examples, the application code 2020 may comprise code to implement one or more of the example methods described herein, for example to implement the steps described above with reference to FIGS. 2 and 7. The application code 2020 may be arranged to cooperate with the program data 2022 or other media, for example to provide the functionality described herein.

In examples, the computing device 2000 may have additional features, functionality or interfaces. For example main unit 2002 may cooperate with one or more peripheral devices for example to implement the methods described herein. In examples, the computing device 2000 comprises, as peripheral devices, an output interface 2024, a peripheral interface 2026, a storage device 208, and a communication module 2030. In examples, the computing device comprises an interface bus 2032 arranged to facilitate communication between the main unit 2002 and the peripheral devices.

In examples, the output device 2024 may comprise output devices such as a graphical processing unit (GPU) 2034 and audio output unit 2036 for example arranged to be able to communicate with external devices such as a display, and/or loudspeaker, via one or more suitable ports such as audio/video (A/V) port. The output device 2024 may be configured to implement the functionality of the output module 110 described herein.

In examples, the peripheral interface 2026 may comprise a serial interface 2038, a parallel interface 2040, and a input/output port(s) 2042 which may be operable to cooperate with the main unit 2002 to allow communication with one or more external input and/or output devices via the I/O port 2042. For example, the I/O port 2042 may communication with one or more input devices such as a keyboard, mouse, touch pad, voice input device, scanner, imaging capturing device, video camera, and the like, and/or with one or more output devices such as a 2D printer (e.g. paper printer), or 3D printer, or other suitable output device.

In examples, the storage device may comprise removable storage media 2044 and/or non-removable storage media 2046. For example, the removable storage media may be random access memory (RAM), electrically erasable programmable read only memory (EEPROM), read only memory (ROM) flash memory, or other memory technology, optical storage media such as compact disc (CD) digital versatile disc (DVD) or other optical storage media, magnetic storage media such as floppy disc, magnetic tape, or other magnetic storage media. However, it will be appreciated that any suitable type of removable storage media could be used. Non-removable storage media 2046 may comprise a magnetic storage media such as a hard disk drive, or solid state hard drive, or other suitable media, although it will be appreciated that any suitable non-removable storage media could be used. The storage device 2028 may allow access by the main unit 2002 for example to implement the methods described herein.

In examples, the communication module may comprise a wireless communication module 2048 and a wired communication module 2050. For example, the wireless communication module may be arranged to communicate wirelessly via a suitable wireless communication standard for example relating to wifi, Bluetooth, near field communication, optical communication (such as infrared), acoustic communication, or via a suitable mobile telecommunications standard. The wired communication module may allow communication via a wired or optical link for example by

Ethernet or optical cable. However, it will be appreciated that any suitable communication module could be used. For example, the communication module may implement the functionality of the interface module 108 described herein.

Referring to FIG. 1, the computing system 100 may be used to implement the methods 200, 700 described herein, and the functionality of the computing system 100 may for example be implemented by the computing device 2000.

It will be appreciated that in examples of the disclosure, elements of the disclosed methods may be implemented in a computing device (such as the computing device described above with reference to FIG. 9) in any suitable manner. For example, a conventional computing device may be adapted to perform one or more of the methods described herein by programming/adapting one or more processors of the computing device. As such, in examples, the programming/adapting may be implemented in the form of a computer program product comprising computer implementable instructions stored on a data carrier and/or carried by a signal bearing medium, such as floppy disk, hard disk, optical disk, solid state drive, flash memory, programmable read only memory (PROM), random access memory (RAM), or any combination of these or other storage media or signal bearing medium, or transmitted via a network such as a wireless network, Ethernet, the internet, or any other combination of these or other networks.

In other words, in examples, a computer program may comprise computer readable instructions which, when implemented on a computing device, cause the computing device to carry out a method according examples of the disclosure. In examples, a storage medium may comprise the computer program, for example, as mentioned above. It will also be appreciated that other suitable computer architectures could be used such as those based on one or more parallel processors. Furthermore, at least some processing may be implemented on one or more graphical processing units (GPUs). Although computing device 2000 is described as a general purpose computing device, it will be appreciated that this could be implemented in any appropriate device, such as mobile phone, smart phone, camera, video camera, tablet device, server device, one or more distributed computing (e.g. cloud computing) devices with modifications and/or adaptation if appropriate to the features described above, for example dependent on the desired functionality and hardware features.

Other aspects and features of the disclosure are described in the following numbered clauses.

1. A method for guiding repair of a vehicle, the method comprising:
receiving, by an interface module, diagnostic trouble codes generated by the vehicle, in which each diagnostic trouble code is associated with at least one fault occurrence of the vehicle having at least one possible cause;
extracting, by a processor, possible causes for a fault occurrence from the diagnostic trouble codes and identifying components of the vehicle that are associated with those causes;
determining, by the processor, common components between the diagnostic trouble codes based on an identification of the components of the vehicle that could be contributing to each fault occurrence, the common components being those that are identified as being associated with fault occurrences of two of more diagnostic trouble codes;
ordering, by the processor, the possible causes based on the identified common components; and
outputting, by an output module, a recommendation for a sequence of repairing the vehicle based on the ordered possible causes.

2. A method according to clause 1, comprising:
generating a total score for each cause that is indicative of the likelihood of that cause contributing to the occurrence of the fault indicated by the associated diagnostic trouble code,
in which ordering the possible causes is based on the respective total score for each cause.

3. A method according to clause 2, in which each total score comprises a matching score based on a degree of matching between components of causes belonging to different diagnostic trouble codes.

4. A method according to clause 3, in which each total score comprises one or more of:
a predictive alert score based on a predictive alert associated with a cause;
a customer feedback score based on customer feedback relating to the occurrence of that cause;
a vehicle repair history score based on repair history of the vehicle;
a symptom score based on reported symptoms coinciding with a fault occurrence.

5. A method according to clause 3 or 4, in which each total score comprises a duration score based on a duration of engine operation for which a diagnostic trouble code is present.

6. A method according to any preceding clause, in which extracting the possible causes from the diagnostic trouble codes and identifying the components of the vehicle that are associated with respective causes is based on a knowledge graph.

7. A method according to clause 6, in which the knowledge graph is generated from the diagnostic fault codes based on utilisation of prompting a large language model to identify the components of the vehicle that are associated with the respective diagnostic trouble codes and determine possible causes of the diagnostic trouble codes.

8. A method according to clause 6 or clause 7, in which the knowledge graph is stored in a memory prior to extracting the possible causes and identifying the components that are associated with them.

9. A method according to clause 6 or clause 7, in which the knowledge graph is generated substantially in real time.

10. A computer program comprising instructions which, when executed by a computer, cause the computer to carry out the method of any of clauses 1 to 9.

11. A non-transitory tangible computer-readable media having stored thereon a computer program according to clause 10.

12. A computing system for guiding repair of a vehicle, the system comprising:
an interface module configured to receive diagnostic trouble codes generated by the vehicle, in which each diagnostic trouble code is associated with at least one fault occurrence of the vehicle having at least one possible cause;
a processor configure to:
   extract possible causes for a fault occurrence from the diagnostic trouble codes and identify components of the vehicle that are associated with those causes;
   determine common components between the diagnostic trouble codes based on an identification of the components of the vehicle that could be contributing to each fault occurrence, the common components being those that are identified as being associated with fault occurrences of two of more diagnostic trouble codes; and
   order the possible causes based on the identified common components; and
an output module configured to output a recommendation for a sequence of repairing the vehicle based on the ordered possible causes.

13. A computing system according to clause 12, in which the processor is configured to generate a total score for each cause that is indicative of the likelihood of that cause contributing to the occurrence of the fault indicated by the associated diagnostic trouble code, and in which ordering the possible causes is based on the respective total score for each cause.

14. A computing system according to clause 12 or clause 13, in which each total score comprises a matching score based on a degree of matching between components of causes belonging to different diagnostic trouble codes.

15. A computing system according to any of clauses 12 to 14, in which each total score comprises one or more of:
a predictive alert score based on a predictive alert associated with a cause;
a customer feedback score based on customer feedback relating to the occurrence of that cause;
a vehicle repair history score based on repair history of the vehicle; and
a symptom score based on reported symptoms coinciding with a fault occurrence.

16. A computing system according to clause 14 or clause 15, in which each total score comprises a duration score based on a duration of engine operation for which a diagnostic trouble code is present.

17. A computing system according to any of clauses 12 to 16, in which the processor is configured to extract the possible causes from the diagnostic trouble codes and identify the components of the vehicle that are associated with respective causes based on a knowledge graph.

18. A computing system according to clause 17, in which the knowledge graph is generated from the diagnostic fault codes based on utilisation of prompting a large language model to identify the components of the vehicle that are associated with the respective diagnostic trouble codes and determine possible causes of the diagnostic trouble codes.

19. A computing system according to clause 16 or clause 17, in which the knowledge graph is stored in a memory prior to extracting the possible causes and identifying the components that are associated with them.

20. A computing system according to clause 16 or 17, in which the processor is configured to generate the knowledge graph substantially in real time.

Although a variety of examples have been described herein, these are provided by way of example only and many variations and modifications on such examples will be apparent to the skilled person and fall within the spirit and scope of the present invention, which is defined by the appended claims and their equivalents.

1. A method for guiding repair of a vehicle, the method comprising:
receiving, by an interface module, diagnostic trouble codes generated by the vehicle, in which each diagnostic trouble code is associated with at least one fault occurrence of the vehicle having at least one possible cause;
extracting, by a processor, possible causes for a fault occurrence from the diagnostic trouble codes and identifying components of the vehicle that are associated with those causes;
determining, by the processor, common components between the diagnostic trouble codes based on an identification of the components of the vehicle that could be contributing to each fault occurrence, the common components being those that are identified as being associated with fault occurrences of two of more diagnostic trouble codes;
ordering, by the processor, the possible causes based on the identified common components; and
outputting, by an output module, a recommendation for a sequence of repairing the vehicle based on the ordered possible causes.

2. A method according to claim 1, comprising:
generating a total score for each cause that is indicative of the likelihood of that cause contributing to the occurrence of the fault indicated by the associated diagnostic trouble code, in which ordering the possible causes is based on the respective total score for each cause.

3. A method according to claim 2, in which each total score comprises a matching score based on a degree of matching between components of causes belonging to different diagnostic trouble codes.

4. A method according to claim 3, in which each total score comprises one or more of:
a predictive alert score based on a predictive alert associated with a cause;
a customer feedback score based on customer feedback relating to the occurrence of that cause;
a vehicle repair history score based on repair history of the vehicle;
a symptom score based on reported symptoms coinciding with a fault occurrence.

5. A method according to claim 3, in which each total score comprises a duration score based on a duration of engine operation for which a diagnostic trouble code is present.

6. A method according to claim 1, in which extracting the possible causes from the diagnostic trouble codes and identifying the components of the vehicle that are associated with respective causes is based on a knowledge graph.

7. A method according to claim 6, in which the knowledge graph is generated from the diagnostic fault codes based on utilisation of prompting a large language model to identify the components of the vehicle that are associated with the respective diagnostic trouble codes and determine possible causes of the diagnostic trouble codes.

8. A method according to claim 6, in which the knowledge graph is stored in a memory prior to extracting the possible causes and identifying the components that are associated with them.

9. A method according to claim 6, in which the knowledge graph is generated substantially in real time.

10. A computer program comprising instructions which, when executed by a computer, cause the computer to carry out the method of claim 1.

11. A non-transitory tangible computer-readable media having stored thereon a computer program according to claim 10.

12. A computing system for guiding repair of a vehicle, the system comprising:
an interface module configured to receive diagnostic trouble codes generated by the vehicle, in which each diagnostic trouble code is associated with at least one fault occurrence of the vehicle having at least one possible cause;
a processor configure to:
extract possible causes for a fault occurrence from the diagnostic trouble codes and identify components of the vehicle that are associated with those causes;
determine common components between the diagnostic trouble codes based on an identification of the components of the vehicle that could be contributing to each fault occurrence, the common components being those that are identified as being associated with fault occurrences of two of more diagnostic trouble codes; and
order the possible causes based on the identified common components; and
an output module configured to output a recommendation for a sequence of repairing the vehicle based on the ordered possible causes.

13. A computing system according to claim 12, in which the processor is configured to generate a total score for each cause that is indicative of the likelihood of that cause contributing to the occurrence of the fault indicated by the associated diagnostic trouble code, and in which ordering the possible causes is based on the respective total score for each cause.

14. A computing system according to claim 12, in which each total score comprises a matching score based on a degree of matching between components of causes belonging to different diagnostic trouble codes.

15. A computing system according to claim 12, in which each total score comprises one or more of:
a predictive alert score based on a predictive alert associated with a cause;
a customer feedback score based on customer feedback relating to the occurrence of that cause;
a vehicle repair history score based on repair history of the vehicle; and
a symptom score based on reported symptoms coinciding with a fault occurrence.

16. A computing system according to claim 14, in which each total score comprises a duration score based on a duration of engine operation for which a diagnostic trouble code is present.

17. A computing system according to claim 12, in which the processor is configured to extract the possible causes from the diagnostic trouble codes and identify the components of the vehicle that are associated with respective causes based on a knowledge graph.

18. A computing system according to claim 17, in which the knowledge graph is generated from the diagnostic fault codes based on utilisation of prompting a large language model to identify the components of the vehicle that are associated with the respective diagnostic trouble codes and determine possible causes of the diagnostic trouble codes.

19. A computing system according to claim 16, in which the knowledge graph is stored in a memory prior to extracting the possible causes and identifying the components that are associated with them.

20. A computing system according to claim 16, in which the processor is configured to generate the knowledge graph substantially in real time.
